(19) United States
(12) Patent Application Publication
(10) Pub. No.: US 2025/0049020 A1
(43) Pub. Date: Feb. 13, 2025

(54) VINE GROWTH PREVENTION SYSTEM

(71) Applicant: Product Launch Advisors, LLC, York, SC (US)

(72) Inventor: Richard O. Gregory, II, York, SC (US)

(21) Appl. No.: 18/797,502

(22) Filed: Aug. 7, 2024

Related U.S. Application Data
(60) Provisional application No. 63/531,292, filed on Aug. 7, 2023.

(51) Int. Cl. A01M 21/02

(52) U.S. Cl. CPC A01M 21/02

(57) ABSTRACT

A vine growth prevention device can include a panel defining a width, a length, and one or more openings, the panel being planar in an installed and unstressed condition, the one or more openings defined in the panel between a first side end and a second side end of the panel; and a fastener configured to secure the panel to a guy wire at and through each of the one or more openings and at a position between the first side end and the second side end. A vine removal tool can include a first portion defining a mounting end; and a second portion defining a working end, the working end defining: a first notch defining a first radius; and a second notch intersecting the first notch and defining a second radius, the first radius being greater than the second radius.

### REFERENCE TO RELATED APPLICATIONS

This application claims the benefit of U.S. Provisional Application No. 63/531,292, filed Aug. 7, 2023, which is hereby specifically incorporated by reference herein in its entirety.

### TECHNICAL FIELD

### Field of Use

This disclosure relates to systems and devices for removing or preventing vine growth on wires such as utility guy wires. More specifically, this disclosure relates to physical devices for mechanically removing or preventing such growth.

### Related Art

Vines, including the plant commonly known as kudzu (genus Pueraria) but also other plants such as grape, Virginia creeper, poison ivy, wisteria, and jasmine, can provide ground cover that has at times in the past proved beneficial, but overgrowth can result in vines climbing utility guy wires and utility poles, many millions of which are positioned across the Unites States and elsewhere. Even if such overgrowth affects only some utility poles, the overgrowth must typically be removed to be able to service the utility systems they support. Due to rapid growth of a plant such as kudzu, time-consuming and costly maintenance at regular intervals can in any case become an unhelpful, potentially hazardous, and otherwise avoidable distraction from and/or interference with more important work performed by utility workers.

### SUMMARY

It is to be understood that this summary is not an extensive overview of the disclosure. This summary is exemplary and not restrictive and is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a vine growth prevention device comprising: a panel defining a width in a transverse direction, a length in a longitudinal direction, and one or more openings, the panel being planar in an installed and unstressed condition and formed from a material defining a flexural strength of 5 to 50 ksi, the one or more openings defined in the panel between a first side end and a second side end of the panel; and a fastener configured to secure the panel to a guy wire at and through each of the one or more openings and at a position between the first side end and the second side end.

In a further aspect, disclosed is a vine removal tool comprising: a first portion defining a mounting end; and a second portion defining a working end, the working end defining: a first notch defining a first radius; and a second notch intersecting the first notch and defining a second radius, the first radius being greater than the second radius.

In yet another aspect, disclosed is a method comprising: obtaining a vine removal tool, the vine removal tool comprising a working end defining: a first notch defining a first radius; and a second notch intersecting the first notch and defining a second radius, the first radius being greater than the second radius; aligning one of the first notch and the second notch with one of a guy wire and a wire guard in which the guy wire is received or to which the guy wire is joined; and engaging the vine removal tool with the one of the guy wire and the wire guard by sliding the vine removal tool up and down the one of the guy wire and the wire guard while generally maintaining contact between the vine removal tool and the one of the guy wire and the wire guard.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, explain various principles of the disclosure. The drawings are not necessarily drawn to scale. Corresponding features and components throughout the figures may be designated by matching reference characters for the sake of consistency and clarity.

FIG. 1A is a side perspective view of a vine growth prevention device installed on a wire or, more specifically, a guy wire above an area of vine growth in accordance with one aspect of the current disclosure.

FIG. 1B is a sectional view of the vine growth prevention device taken along line 1B-1B of FIG. 1A.

FIG. 2 is a side elevation view of a vine growth prevention panel of the vine growth prevention device of FIG. 1A.

FIG. 3 is a side elevation view of the vine growth prevention panel of FIG. 2 in accordance with another aspect of the current disclosure.

FIG. 4 is a detail view of the vine growth prevention panel of FIG. 1A taken from detail 4 of FIG. 3.

FIG. 5 is a perspective view of a fastener of the vine growth prevention device of FIG. 1A.

FIG. 6 is a top perspective view of the vine growth prevention device of FIG. 1A during a first step of a method of installing the vine growth prevention device to the guy wire of FIG. 1A showing assembly of a plurality of fasteners to the vine growth prevention panel of FIG. 3.

FIG. 7 is a side perspective view of the vine growth prevention device of FIG. 1A during a first step of a method of installing the vine growth prevention panel to the guy wire of FIG. 1A with the plurality of fasteners.

FIG. 8 is a side perspective view of the vine growth prevention device of FIG. 1A after installation on the guy wire of FIG. 1A.

FIG. 9A is a side elevation view of the vine growth prevention device of FIG. 1A after installation on the guy wire of FIG. 1A and showing an attached measurement line.

FIG. 9B is a detail side elevation view of a portion of the vine growth prevention device of FIG. 9A taken from detail 9B of FIG. 9A.

FIG. 9C is a side elevation view of the vine growth prevention device of FIG. 1A after installation on the guy wire of FIG. 1A and additionally secured to a second guy wire.

FIG. 9D is a free body diagram or schematic representing a side elevation view of the vine growth prevention device of FIG. 1A after installation on the guy wire of FIG. 1A.

FIG. 10 is a top plan view of a vine removal tool in accordance with one aspect of the current disclosure.

FIG. 11 is a top plan view of a vine removal tool in accordance with another aspect of the current disclosure.

FIG. 12 is a side perspective view of a first portion of the vine removal tool at least partially assembled to an extension member, the mounting portion shown in accordance with one aspect of the current disclosure.

FIG. 13 is a side perspective view of the first portion of the vine removal tool at least partially assembled to an extension member, the mounting portion shown in accordance with another aspect of the current disclosure.

FIG. 14 is a side perspective view of the vine removal tool of FIG. 11 assembled to the extension member of FIG. 12.

FIG. 15 is a detail side perspective view of assembly of FIG. 14.

FIG. 16 is a side top perspective view of a user removing a vine from the guy wire of FIG. 1A with the vine removal tool of FIG. 10.

FIG. 17 is a front top perspective view of the user removing a vine from the guy wire of FIG. 1A with the vine removal tool of FIG. 10.

FIG. 18 is a side bottom perspective view of the user removing a vine from a wire guard surrounding the guy wire of FIG. 1A with the vine removal tool of FIG. 10.

FIG. 19 is a side top perspective view of the user holding a vine removal system comprising the vine removal tool of FIG. 10 and the extension member of FIG. 13 and engaging the guy wire of FIG. 1A with the vine removal device.

FIG. 20 is a detail view of the vine removal system of FIG. 19 showing the vine removal tool of FIG. 10 engaged with the guy wire of FIG. 1A and taken from detail 20 of FIG. 19.

FIG. 21 is a detail view of the vine removal device comprising the vine removal tool of FIG. 11 and being pushed against the guy wire of FIG. 1A in a direction away from the user taken from detail 20 of FIG. 19.

FIG. 22 is a detail view of the vine removal system of FIG. 21 being pulled against the guy wire of FIG. 1A in a direction towards from the user taken from detail 20 of FIG. 19.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams. Unless otherwise specified herein, any structure disclosed in the drawings or in the written description as being so formed can be monolithic whether or not such an explicit description of the structure is included herein.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of a system or device disclosed herein nearest to and occupied by a user of the system or device; “rear” is that end of the seat that is opposite or distal the front; “left” is that which is to the left of or facing left from a person facing towards the front; and “right” is that which is to the right of or facing right from that same person facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

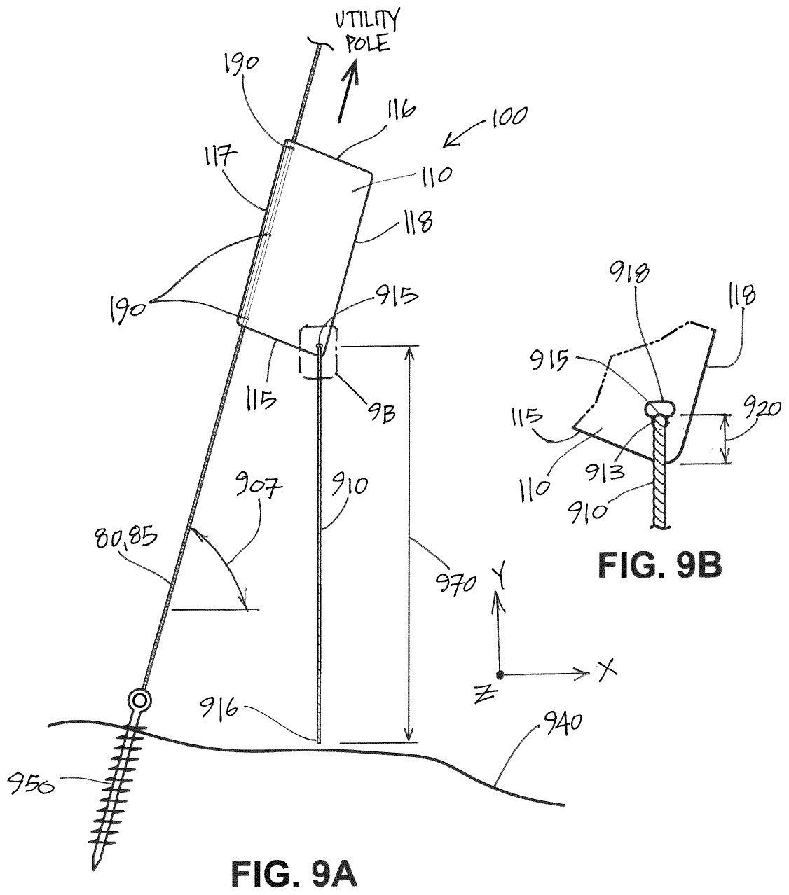

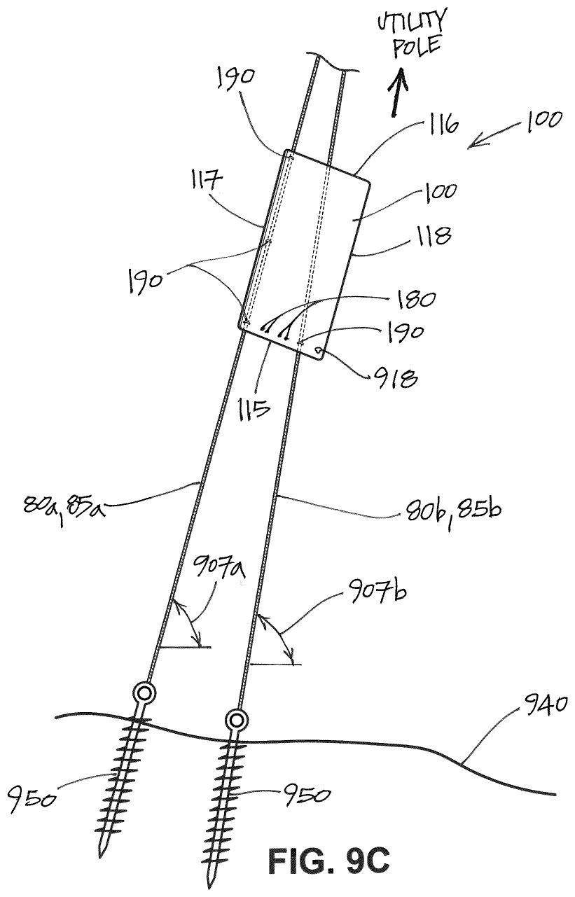

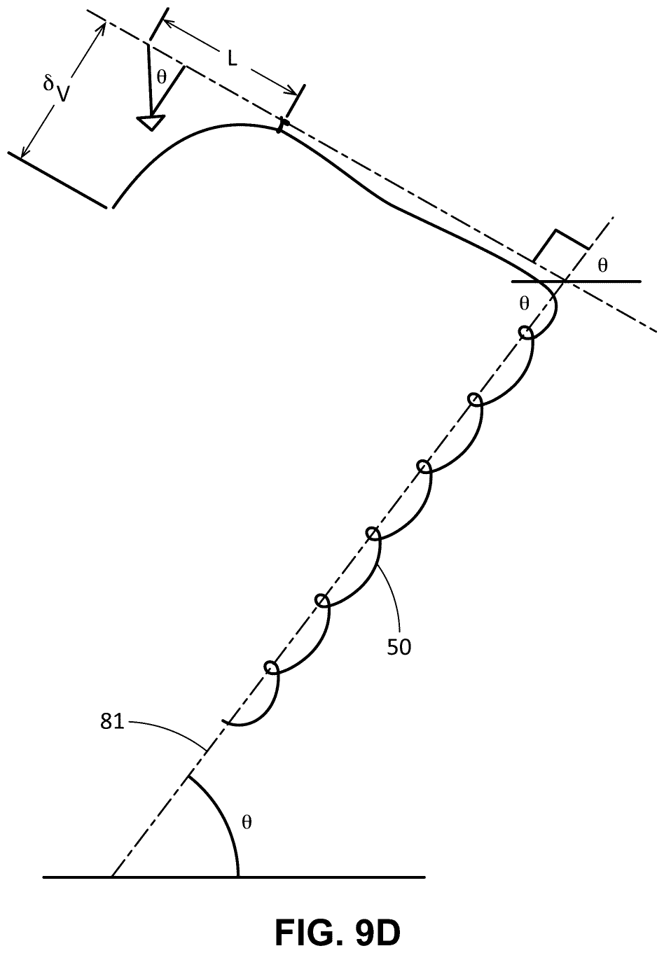

The system or device can also be described using a coordinate axis of X-Y-Z directions shown in FIG. 9A. An X-axis direction can be referred to as a left-right or horizontal direction. An upper-lower direction is a Y-axis direction orthogonal to the X-axis direction and to a Z-axis direction. The Z-axis direction is orthogonal to the X-axis direction (left-right direction) and the Y-axis direction (upper-lower direction) and can also be referred to as a front-rear direction. A surface of a structural element that is parallel with the front-rear direction can be referred to as a lateral side.

In one aspect, a vine growth prevention system and associated methods, systems, devices, and various apparatuses are disclosed herein. In some aspects, the vine growth prevention system can comprise a vine growth prevention. In some aspects, the vine growth prevention system can comprise a vine growth removal tool.

As disclosed in the following brief history of the plant taken from U.S. Pat. No. 6,684,578 to Callahan, kudzu is infamous as a non-native invasive plant that traces its history in the United States nearly 150 years back. Kudzu was introduced in the United States in 1876 at the Centennial Exposition at Philadelphia, Pennsylvania. In the 1920s it was discovered that animals would eat the plant and it was promoted as forage at that time. In the 1930s, the Soil Conservation Service promoted the use of kudzu for erosion control. Kudzu is common throughout the United States and especially the southeastern parts.

Kudzu is a non-native trifoliate-leafed, semi-woody climbing vine. The vines are capable of growing up to 60 feet in a single season with as much as one foot per day during early summer. The starchy, tuberous root can reach a depth of 12 feet and weigh between 200 to 300 pounds. Vines spread growing from a root crown and will root every few feet at the nodes forming a new plant. Mature stands may have a plant every one to two feet and one acre can easily contain tens of thousands of plants.

While primarily a problem in the southeastern United States, kudzu has spread to the northeast and midwestern regions as well. It is estimated that millions of acres, including farmland, forest land, highway, and utility right of ways, have been ensnared and increasingly taken over by the plant.

Conventional methods of controlling kudzu including herbicides, grazing, mechanical removal, and burning. While herbicides can kill the vegetation, repeated treatments are necessary, sometimes for as many as five to ten years, and the associated chemicals may not be particularly environmentally friendly and/or may be relatively expensive. Grazing animals will readily eat kudzu foliage. Overgrazing is a possible treatment when the grazing animals are fenced within an area of kudzu. If any of the kudzu extends beyond the boundary of the fenced areas, however, the infestation typically begins anew as soon as the animals are removed. Mechanical removal may be utilized, but it is preferred to remove the roots. While mowing, weeding, or other mechanical removal techniques can provide short-term relief, the plant will return if the roots are not also removed. Finally, prescribed burning will weaken the roots by consuming the foliage, but burning brings with it its own risks and must generally be repeated.

Moving from this history, it has been discovered that vines such as kudzu share several common characteristics. One, vines generally grow away from gravity or, put differently, against the force of gravity, i.e., they climb ever higher until their own collective weight and/or density causes their growth to either be redirected or stall. Two, vines generally climb by encircling the structure being climbed. Three, vines generally grow toward light. Four, vines generally co-mingle, i.e., grow together, to expand further than any individual vine might extend on its own. Five, as discovered through testing, certain geometries repel vines such as kudzu and can thereby inhibit growth. As much as is known about the growth of kudzu and other vines, existing methods for vine growth prevention and vine removal are lacking and, bottom line, impractical and/or expensive.

Applicant experimented with a variety of vine growth prevention devices by trying various geometries and materials, alone or in combination, in a large kudzu “field.” Plates or sheets or panels positioned perpendicularly to a simulated wire such as rebar, sometimes in combination with other geometries such as hollow or solid cone shapes, were found to be effective in slowing or redirecting vine growth compared to a control lacking any barriers to vine growth. With the use of more opaque materials, light from the sun was blocked but vines grew aggressively in an effort to reach more light. Use of more translucent material resulted in more light reaching the plants, but the plants did not appear as healthy. Thicker materials were found to hold their shape better. While geometries oriented perpendicularly with respect to the structure being climbed, e.g., a guy wire or simulation thereof, hindered growth, such hindrance to growth lasted for only a limited time.

Further experimentation revealed that aligning a plane of a plate or panel of a vine growth prevention device with the climbing structure, e.g., the guy wire, similar to the way in which a flag is aligned with a flag pole or a flag halyard to which the flag is attached, could prevent a vine and, more specifically, a kudzu vine from wrapping around the wire. More generally, the structures and methods resulting from the experimentation can prevent vines from climbing guy wires and other structures, resulting in less maintenance for utility companies and safer work environments for line workers, and can facilitate remove of vine growth, especially ahead of the installation of preventative measures.

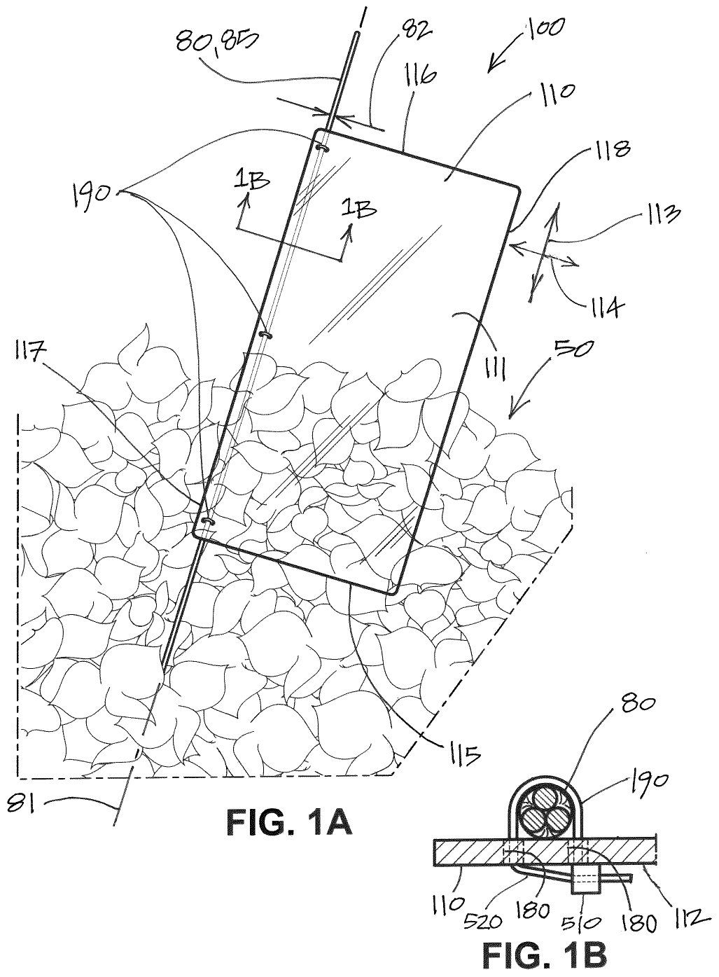

FIG. 1A is a side perspective view of a vine growth prevention device or device 100 installed on a climbing structure 80 above an area of vine growth 50 such as, for example and without limitation, the kudzu plant shown, in accordance with one aspect of the current disclosure. In some aspects, the vine can be or can comprise a kudzu plant. In some aspects, the vine can be or can comprise another plant. In some aspects, the climbing structure 80 can be or can comprise a guy wire 85. In some aspects, the climbing structure 80 can be or can comprise any other structure extending in a vertical direction including a cable cover or cable wrap or wire cover or wire guard 1810 (shown in FIG. 18) surrounding the guy wire 85. The guy wire 85 can itself extend from the ground and can be angled with respect to each of or either of the ground and another structure such as a utility pole. The guy wire 85 can define a diameter 82. In some aspects, the diameter 82 can measure ⅜ inch (or about 9.5 millimeters). In some aspects, the diameter 82 can measure 7/16 inch (or about 11.1 mm).

The climbing structure 80 and, more specifically, the guy wire 85 can be or can comprise a stranded metal rope, which can be insulated or otherwise wrapped or coated or can remain bare. As shown at least in FIG. 9A, the climbing structure 80 and, more specifically, the guy wire 85 can be anchored to each of the ground and a vertical structure such as the utility pole. In some aspects, the guy wire 85 can be pulled taught between the ground and a vertical structure or between any other structures, whether natural or manmade. In some aspects, the guy wire 85 need not be pulled taught.

The device 100, which can be an effective and durable barrier to the vine growth 50, can comprise a vine growth prevention panel or panel 110. The panel 110 can comprise a first surface 111 and a second surface 112 (shown in FIG. 1B) opposite from the first surface 111. The panel 110 can define a bottom end or first longitudinal end or first end 115, a top end or second longitudinal end or second end 116, a first side end or first transverse end or mounting end 117, and a second side end or second transverse end or mounting end 118.

In some aspects, the panel 110 can be formed from a sheet, which can be extruded or formed in a mold. In some aspects, the panel 110 can comprise one or more plies of a corrugated panel. In some aspects, the panel 110 be opaque or can be formed from an opaque material configured to not allow the passage of light. In some aspects, the panel 110 can be translucent or can be formed from a translucent material configured to allow some passage of light (for example, at least 5%). In some aspects, the panel 110 can be clear or can be formed from a clear material configured to allow passage of all light or substantially all light (for example, at least 95%). In some cases, a material forming the panel 110 can allow passage of some wavelengths but not certain other wavelengths such as, for example and without limitation, ultraviolet wavelengths. The panel 110 can be formed from any one or more of various materials such as, for example and without limitation, a metallic material, a polymeric material, or fabric material, and/or a composite material. Metallic materials can include, for example and without limitation, aluminum (e.g., 5052 AL). Polymeric materials can include, for example and without limitation, acrylic, polycarbonate, polyethylene (e.g., high-density polyethylene or HDPE), polypropylene, acetyl or polyacetal or polyoxymethylene (POM) (e.g., a DELRIN resin available from DuPont de Nemours, Inc.), and polytetrafluoroethylene (PTFE). Fabric materials can include, for example and without limitation, canvas. Composite materials can include, for example and without limitation, a glass-filled or glass-reinforced polymer, which can also be considered polymeric materials. In some aspects, the material can be UV-resistant to last two years or more in a natural outdoor environments. In some aspects, the panel 110 can define a thickness of between 0.020 inches (approximately 0.5 millimeters) and 0.0625 inches (approximately 1.6 millimeters).

In some aspects, the panel 110 can be rigid, which means the panel 110 resists folding or crumpling in the wind, as a thin plastic film or flag would generally move. More specifically, in some aspects, a material forming the panel 110 can define a flexural strength of 5 to 50 ksi, inclusive. In some aspects, a material forming the panel 110 can define a flexural strength of 40 to 50 ksi, inclusive. In some aspects, a material forming the panel 110 can define a flexural strength of 5 to 20 ksi, inclusive. In some aspects, a material forming the panel 110 can define a flexural strength of at least 5 ksi, inclusive. In some aspects, the panel 110 need not be rigid. More specifically, a material forming the panel 110 can define a flexural strength of less than 5 ksi. In some aspects, the geometry can be more important than the material properties because the shape of the material can by itself prevent the vine from encircling and climbing the climbing structure 80.

The device 100 can further comprise one or more fasteners 190, each of which can be configured to secure the panel 110 to the climbing structure 80. In some aspects, as shown, a plurality of fasteners 190 can secure the panel 110 to the climbing structure 80. In some aspects, as also shown, a plurality of fasteners 190 can secure the panel 110 to the climbing structure 80 at positions spaced apart in a longitudinal direction 113 of the panel 110, which can be defined with respect to an axis 81 of the climbing structure 80. As specifically shown, a fastener 190 can secure the panel 110 to the climbing structure 80 proximate to each of two corners of the panel 110 and an additional one of the one or more fasteners 190 can secure the panel 110 to the climbing structure 80 at a position located between the two corners. In some aspects, a single instance of the fastener 190 can secure the panel 110 to the climbing structure 80. For example and without limitation, a fastener 190 can engage and secure a middle portion of the panel 110 to the climbing structure 80, and slots and/or hook features defined in the panel 110 in locations offset from the portion receiving the fastener 190 can otherwise lock a position of the panel 110 with respect to the climbing structure 80. In some aspects, as shown, the panel 110 or the edge 117 thereof need not wrap around the guy wire 85. In some aspects, as shown, the panel 110 or the edge 117 thereof can overlap or extend past the guy wire 85 by a distance sufficient to facilitate attachment of the panel 110 with the plurality of fasteners 190. In some aspects, the panel 110 or the edge 117 thereof need not overlap or extend past the guy wire 85

FIG. 1B is a sectional view of the vine growth prevention device 100 taken along line 1B-1B of FIG. 1A. In some aspects, as shown, the panel 110 can be secured to the guy wire 85. In some aspects, the panel 110 can be secured to the wire guard 1810 (shown in FIG. 18) surrounding the guy wire 85 or, again, to any climbing structure 80 from which the vine growth 50 is to be prevented or retarded. More specifically, the one or more fasteners 190 can extend through the panel 110 and, more specifically, each of one or more openings defined in the panel 110 and sized to receive one of the one or more fasteners 190. More specifically, the fastener 190 can extend through a first opening 180 defined in the panel 110, can wrap around the guy wire 85, and can be inserted through a second opening 180 defined in the panel 110; and a tail 520 of the fastener 190 can be engaged with itself (e.g., a head 510 of the fastener 190). In some aspects, a head of the fastener 190 can keep the fastener 190 from sliding through the opening 180. As shown, the panel 110 can receive the fastener 190 through one or more of a plurality of openings 180. The device 100 can receive as many fasteners 190 as needed or desired to secure the panel 110 in place on the climbing structure 80.

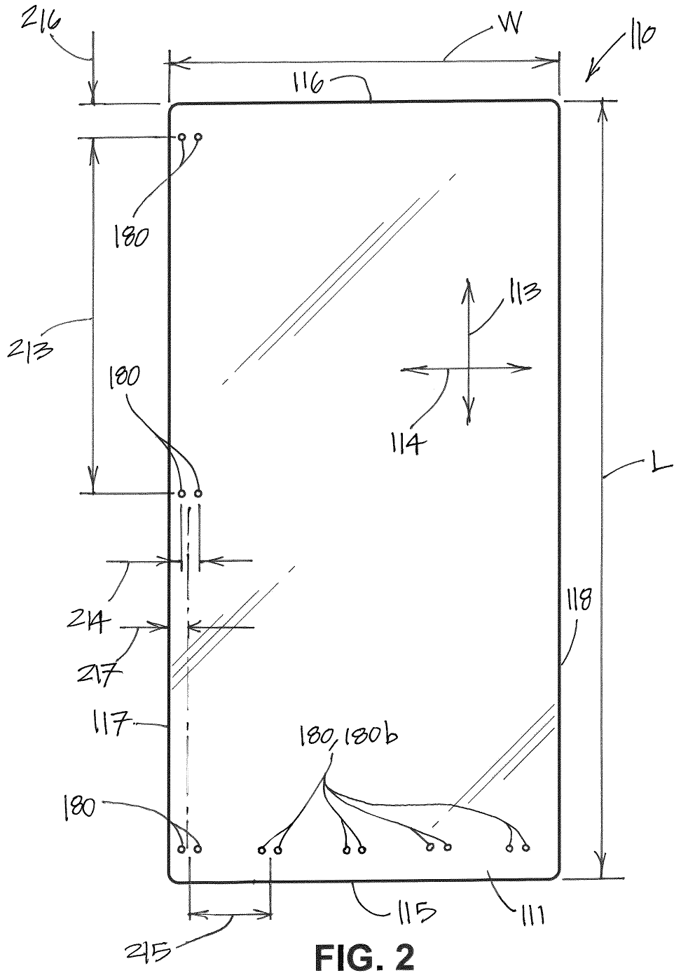

FIG. 2 is a side elevation view of the panel 110 of the vine growth prevention device 100 of FIG. 1A. In some aspects, as shown, the panel 110 can define a rectangular shape, which can result in efficient raw material usage during the manufacturing process. In some aspects, the panel 110 can more generally define a polygonal shape, which can be non-rectangular. For example and without limitation, the panel 110 can define a rectangular shape proximate to the first end 115 (for example, a first longitudinal half of the panel 110), where a larger panel is desired to block vine growth, and a triangular shape proximate to the second end 116 (for example, a second longitudinal half of the panel 110), where a vine is less likely to wrap around the climbing structure 80. More specifically, the panel 110 can define a rhombus shape. The panel 110 can thus, more generally, vary in width over its length, which can result in benefits such as, for example and without limitation, a reduction in material usage and/or a reduction in a weight of the panel 110. Any shapes defined by all or portions of the panel 110 can be substantially such a shape. For example, corner treatments (e.g., radii R, as shown in FIG. 4, or chamfers) or local features such as edge treatments (e.g., notches in any of the ends of the panel 110) can be ignored, i.e., the panel 110 can still be rectangular if corners of the panel 110 are radiused or chamfered. As shown, at least in an unloaded or unstressed condition (e.g., when supported by a planar surface or when installed on a guy wire but not buffeted by wind), the panel 110 can be planar from the first end 115 to the second end 116 or from the first side end 117 to the second side end 118. In some aspects, as also shown, the panel 110 can be flat, which can mean smooth and/or free from marked lumps or indentations.

The panel 110 can define a width W and a length L. The width W can be measured in a transverse direction 114 of the panel 110, and the length L can be measured in the longitudinal direction 103. The panel 110 can define a plurality of openings 180. As shown, one of the fasteners 190 can be received through a pair of the openings 180 to secure the panel 110 to the climbing structure 80.

As shown in FIG. 9D, a vine can essentially be represented as a cantilevered beam. If material properties are applied to this beam and dimensions are assumed for the beam size, a predictive model can be created which shows how the vine, when self-supported, cannot continue to climb on its own due to the bending stress. When the stress limit is reached, the beam (i.e., the vine) folds over on itself and falls to the ground (but ever in search of something to latch onto so that it can continue its encircling climb). Also, as an angle 907 (shown in FIG. 9A) or angle θ (shown in FIG. 9D) of the guy wire 85 to the ground 940 increases, the horizontal component of the mass of the vine decreases and the length of the vine can increase without reaching its bending stress limit, all other parameters like diameter and modulus of the vine remaining constant. For any given angle 907 or angle θ of the guy wire 85—and to help determine a desirable width W of the panel 110—a length L or Lᵥ of the vine where collapse of the vine under its own weight will occur can be calculated based on the following formula:

$${L}_{V} = {( \frac{δ \cdot 3 \cdot E \cdot π {d}^{4}}{64 \cdot mg \cdot sin θ} )}^{1 / 3} ,$$

where δ is the deflection of the vine (e.g., 1 inch being considered representative of a vine that has collapsed), E is Young's modulus (e.g., 100,000 psi), d is the diameter of the vine (e.g., 0.5 inches), m is the mass of the vine (e.g., 0.05 pounds, which can be assumed to be a point load acting at the end of the vine but can be a distributed load and the weight adjusted appropriately), g is the acceleration of gravity (e.g., 32.2 ft/s²), and θ is the angle 907. Accordingly, in some aspects, a minimum or desired value for the width W can equal the calculated value for the length Lv according to the formula above. In some aspects, an extension distance 960 from a center of the guy wire 85 to the side end 118 can equal the calculated value for the length Lv according to the formula above, and the width W can be determined from the extension distance 960 based on the geometry of the panel 110, including the values for an edge offset distance 217 and a spacing 214. In some aspects, the width W can be further adjusted by a safety factor (e.g., a safety factor or adjustment of 10% or more including 2×, 3×, or another multiple of the calculated width W) to adjust or compensate for variability in one or more of the variables.

In some aspects, it has been found that the width W can measure at least or at most 10 inches. In some aspects, the width W can measure at least 12 inches. In some aspects, the width W can measure at least about 24 inches. In some aspects, the width W can measure 23.75 inches to account for raw material and manufacturing process considerations. The length L can measure at least or at most the width W or, in some aspects, 12 inches. In some aspects, the length L can measure at least or at most 1.5 times the width. In some aspects, the length L can measure at least or at most two times the width. In some aspects, the length L can measure at least or at most three times the width. In some aspects, the length L can measure more than three times the width. In some aspects, the length L can measure at least 24 inches. In some aspects, the length L can measure at least 36 inches.

In some aspects, the length L can measure at least 48 inches. In some aspects, two or more panels 110 can be stacked in series on the guy wire 85 to achieve the same result as a single panel 110. One or more fasteners 190 can be used to secure a first side end 117 of each panel 110 to the guy wire 85, and one or more fasteners 190 can likewise be used to secure ends 115,116 to each other through the openings 180 and, more specifically, the openings 180b (shown in FIG. 2) extending in the transverse direction 114 or in a direction otherwise angled with respect to the longitudinal direction 113. In some aspects, the first side end 117 of one panel 110 can be secured to the second end 118 of another panel to simulate the structure and effect of a larger panel 110. In some aspects, the length L—either of a single monolithic panel 110 or a composite of two or more panels 110 stacked in series—can measure 47 inches to account for raw material and manufacturing process considerations. In some aspects, either or both of the width W and the length L can be smaller by maintaining a minimum distance 970 of the device 100 above the ground 940 through, for example and without limitation, use of the measurement line 910.

Adjacent openings 180 of sets or, as more specifically shown in FIG. 2, pairs of the openings 180, which can define separate fastening locations, can be spaced apart in the longitudinal direction 113 of the panel 110 by a spacing 213. More specifically, as shown, the panel 110 can define three fastening locations and three corresponding sets of the openings 180. Adjacent openings 180 in each set or, as shown, pair of the openings 180 can be spaced apart in the transverse direction 114 of the panel 110 by the spacing 214. The sets or pairs of the openings 180 spaced apart in the transverse direction 114 or, more generally, in a direction angled with respect to the longitudinal direction 113 can be spaced apart by a spacing 215. In some aspects, more than two openings 180 can be arranged for each fastener 190 such that, for example and without limitation, the number or positions of the openings 180 receiving the fastener 190 can be adjusted to accommodate the characteristics of the climbing structure 80. In some aspects, a single opening 180 can be arranged for each fastener 190, which can be extend around an outside edge of the panel 110 such as the first side end 117 before engaging with itself. Openings 180 nearest to a side end of the panel 110 such as, for example and without limitation, the first side end 117, can be offset from that end by the edge offset distance 217, while openings 180 nearest to an end of the panel 110 such as, for example and without limitation, the second end 116, can be offset from that end by an edge offset distance 216. As shown, two or more openings 180 can be aligned along either the longitudinal direction 113 or the transverse direction 114. Any of the dimensions or spacings defined herein with respect to the openings 180 can be center-to-center dimensions.

In some aspects, as shown, the openings 180 can be configured to communicate to a user or installer of the vine growth prevention device 100 where the fasteners 190 (shown in FIG. 1A) are to be assembled to the panel 110. In some aspects, additional instances of the openings 180 can be defined in the panel 110—spaced about by one inch, for example—and the user and/or installer can attach as many or as few fasteners 190 as desired or needed to secure the panel 110 to the climbing structure 80 through the desired openings 180 and can leave the other openings 180 unused. As specifically shown, a plurality of openings 180 can be defined in each of two corners of the panel 110 and an additional one of the openings 180 can secure the panel 110 to the climbing structure at a position located between the two corners. In some aspects, multiple fasteners 190 can secure the panel 110 to the climbing structure at a single fastening location. For example, a cross pattern formed by four openings 180 at a single fastening location can further strengthen the attachment between the panel 110 and the climbing structure 80.

As shown, additional sets or pairs of openings 180 and, more specifically, openings 180b, can be defined in the panel 110 and can extend in a direction that is angled with respect to and, more specifically, perpendicular to the longitudinal direction 113, e.g., the transverse direction 114. Such additional openings 180, which can for example be defined along the first end 115 and/or the second end 116, can used to attach the panel 110 to a second climbing structure 80 (e.g., other guy wires 85 positioned below the top guy wire 85 in a plane, which is not uncommon). Such an L-shaped or C-shaped or O-shaped pattern of the openings 180 along two or three sides such as the first side end 117 and the first end 115 and/or the second end 116 and, naturally, even also along the second side end 118 can, again, facilitate the stacking of multiple panels 110 in the longitudinal direction 113 and/or the transverse direction 114 to simulate the structure and effect of a single larger or taller panel 110. By stacking multiple panels 110, a single size of the panel 110 can be stocked and nonetheless used to create any one of multiple sizes of a composite panel extending further in the longitudinal direction 113 and/or the transverse direction 114 where, for example, the vine growth 50 (shown in FIG. 1A) is found to be larger and/or more aggressive. Such fastening to other guy wires 85 can prevent growth of a vine past the panel 110 via a neighboring guy wire 85, especially since it is not uncommon for multiple guy wires 85 to be installed in the same plane to a single utility pole. Each vertical plane in which a guy wire 85 is positioned can have the panel 110 attached to the top guy wire 85. As desired, additional panels 110 can be secured to additional guy wires 85 to block vine growth up any of the potential climbing structures 80.

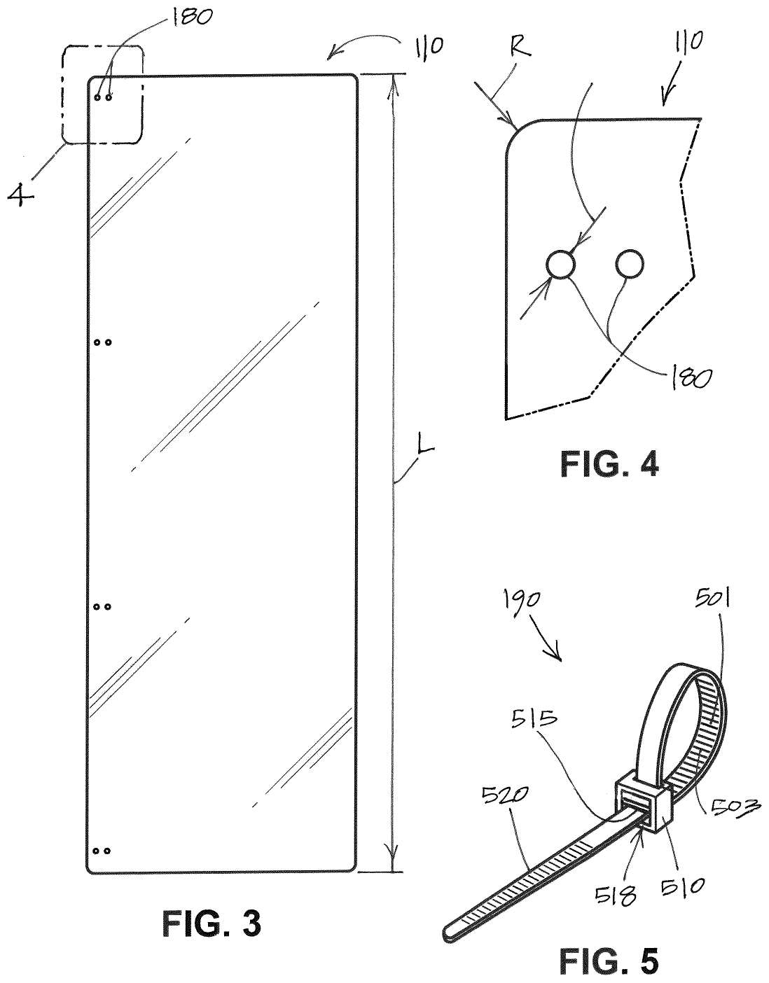

FIG. 3 is a side elevation view of the vine growth prevention panel 110 of FIG. 2 in accordance with another aspect of the current disclosure. As shown, the length L of the panel 110 can be increased. Again, as shown, the length L of the panel 110 can measure 36 inches. As also shown, the panel 110 can define four fastening locations and four corresponding sets of the openings 180.

FIG. 4 is a detail view of the vine growth prevention panel 110 of FIG. 1A taken from detail 4 of FIG. 3. In some aspects, as shown, each of or any of the openings 180 can define a circular shape. In some aspects, each of or any of the openings 180 can define an elliptical or oval shape. In some aspects, each of or any of the openings 180 can define a slotted hole, which can define a constant width slot with semicircular ends. In some aspects, each of or any of the openings 180 can define another closed shape. In some aspects, each of or any of the openings 180 can define an open shape such as, for example and without limitation, a notch in one of the ends 115,116,117,118 of the panel 110. Each of the openings 180 can define a diameter 407 or, in the case of a non-circular opening 180, a maximum dimension in a first direction, e.g., a longitudinal direction of the opening 180, and a maximum width in a second direction angled at 90 degrees with respect to the first direction. In some aspects, the spacing 214 between the openings 180 can measure approximately 0.375 inches or at least 0.375 inches.

FIG. 5 is a perspective view of the fastener 190 of the vine growth prevention device 100 of FIG. 1A. In some aspects, as shown, the fastener 190 can be a flexible one-piece fastener such as the type commonly referred to as a cable tie or zip tie or, in some cases, a wire tie. As shown, the fastener 190 can define at least the head 510 and the tail 520, which can be configured to be received within, engaged with, and locked with respect to the head 510. More specifically, the tail 520 can be received within an opening 518 defined in the opening, and through a one-way ratcheting motion ridges on a surface of the tail 520 such as an inner surface 501 can engage a pawl 515 on the head 510. In some cases, as shown, the fastener 190 can be configured to secure the panel 110 to the climbing structure as long as the fastener 190 remains intact. The fastener 190 can define an anti-slip feature 503 on an inner surface 501. In some aspects, the anti-slip feature can be integral to the material forming the fastener, e.g., ridges defined in the inner surface 501, which can be the same ridges that engage with the head 510 during assembly of the fastener 190. In some aspects, the anti-slip feature can be formed from a separate material than the material forming the fastener, e.g., a material resulting in a higher coefficient of friction being bonded to or coextruded on the inner surface 501.

For example and without limitation, the fastener 190 can be a Series No. 70215K96 cable tie from McMaster-Carr. The fastener 190 can be configured to be UV-resistant (to more readily withstand direct sunlight), can be rated for outdoor use, can be 8 inches long, can be of a one-time use variety (i.e., removable only by destroying the cable tie), and can be formed from a polymer material such as a polyamide. In some aspects, the fastener 190 can have at least a 20-pound break force. In some aspects, the fastener 190 can have at least a 40-pound break force.

In some aspects, the fastener 190 can be a wire tie or twist tie, which can comprise a flexible metallic wire such as the type commonly used to seal a bag containing a loaf of bread. In some aspects, an adhesive or a material comprising adhesive (e.g., tape) can attach the panel 110 to the climbing structure 80 if used in sufficient quantity. In some aspects, the fastener 190 can be a threaded fastener such as a screw or bolt (including U-bolt). In some aspects, the fastener 190 can be a non-threaded fastener such as a rivet. In some aspects, the fastener 190 can extend through not only the panel 110 but also a backing plate or panel or strip and/or washers for reinforcement and to distribute the clamping force. In some aspects, a bracket (e.g., a one-piece molded bracket having a clam-shell design or a two-piece structure comprising two mating halves) can wrap around and receive each of the climbing structure 80 and the panel 110, and one or more of the fasteners 190 can extend through both the bracket and the panel 110 and thereby fix a position of the panel 110 with respect to the climbing structure 80. In some aspects, the fastener 190 can be set based on the weight of the panel 110 and the material and finish properties of the climbing structure 80.

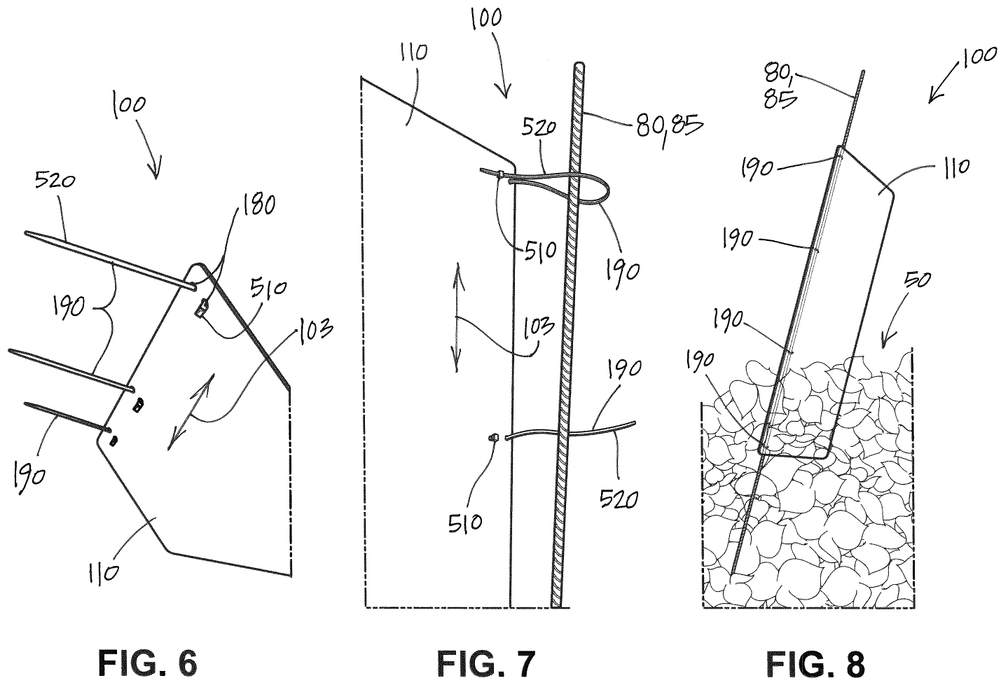

FIG. 6 is a top perspective view of the vine growth prevention device 100 of FIG. 1A during a first step of a method of installing the vine growth prevention device 100 to the guy wire 85 of FIG. 1A showing assembly of a plurality of the fasteners 190 to the vine growth prevention panel 110 of FIG. 3. Again, as previously described, each of the fasteners 190 can extend through the first opening 180 defined in the panel 110, can wrap around the guy wire 85 or other climbing structure 80, and can be inserted through the second opening 180 defined in the panel 110. In some aspects, as shown, each of the fasteners 190 and, more specifically, the tail 520 thereof can extend through the first opening 180 defined in the panel 110 and can be inserted through a second opening 180 defined in the panel 110 in preparation for being wrapped around the guy wire 85 or other climbing structure 80.

FIG. 7 is a side perspective view of the vine growth prevention device 100 of FIG. 1A during a first step of a method of installing the vine growth prevention panel 110 to the guy wire 85 of FIG. 1A with the plurality of fasteners 190. In some aspects, each of the fasteners 190 and, more specifically, the tail 520 thereof can wrap or be wrapped around the guy wire 85 or other climbing structure 80 and then engaged with the head 510 of the corresponding fastener 190. Again, the head 510 of the fastener 190 can be larger than the opening 180 (shown in FIG. 4) and can thereby be kept from sliding or slipping or pulling through the opening 180. The method of assembling the device 100 can comprise placing an end of the panel 110 such as a first side end 117 of the panel 110 in contact with the climbing structure 80 such as the guy wire 85 shown, which can be angled with respect to each of the ground and an utility pole. The method can comprise securing the panel 110 to the climbing structure 80 with the fastener 190.

FIG. 8 is a side perspective view of the vine growth prevention device 100 of FIG. 1A after installation on the guy wire 85 of FIG. 1A. The fastener 190 can be configured to be tightened sufficiently so that the panel 110 does not slide down the climbing structure 80, and the method of assembly can comprise tightening the fastener 190 sufficiently so that the panel 110 does not slide down the climbing structure 80. The method can comprise, such as when multiple guy wires 85 exist in a vertical plane, securing the panel 110 to a lower guy wire 85 after securing to an upper guy wire 85 in the same plane. Again, in some aspects, the panel 110 can be opaque.

FIG. 9A is a side elevation view of the vine growth prevention device 100 of FIG. 1A after installation on the guy wire 85 of FIG. 1A and showing an integral measurement line 910. The guy wire 85 can be secured in the ground 940 with an anchor 950 and can be angled with the horizontal by the angle 907. The measurement line 910 can comprise or be formed from a length of flexible material such as, for example and without limitation, twine, rope, or chain. More specifically, the measurement line 910 can comprise or be formed from hemp or cotton twine, which can define a nominal diameter of 2 millimeters. In some aspects, a length 970 of the measurement line 910, which can define a first end 915 and a second end 916, can measure at least three feet or, to be more accurate, the length 970 of the measurement line 910 can measure at least three feet plus an offset distance 920 (shown in FIG. 9B) by which the first end 915 of the measurement line 910 is offset from an edge of the panel 110. In some aspects, the length 970 can measure at least four feet or, to be more accurate, the length 970 can measure at least four feet plus the offset distance 920. In some aspects, the length 970 of the measurement line 910 can measure at least five feet or, to be more accurate, the length 970 can measure at least five feet plus the offset distance 920. The length 970 can correspond to a minimum distance from the bottom of the device 100 to the ground 940. In some aspects, the length 970 can be lengthened to adjust for hilly conditions in which the bottom of the device 100 may be closer than the length 970 would reflect, at least when the length 970 is measured in a vertical orientation. The measurement line 910 can be attached to the panel 110 and the panel 110 positioned and secured on the climbing structure 80 that that the panel 110 is at least the desired distance from the ground 940, which can be at least three feet and, more ideally, at least four feet. Beyond these distances from the ground 940 it is increasingly difficult for kudzu to support itself in an open field without trees or other climbing structures 80 such as the guy wire 85 shown. By positioning the panel 110 at least three feet and, more ideally, at least four feet or even five feet above the ground 940, which can be easily confirmed with the measurement line 910, the panel 110 and, more generally, the device 100 can even be made smaller than if it were positioned closer to the ground 940.

FIG. 9B is a detail side elevation view of a portion of the vine growth prevention device 100 of FIG. 9A taken from detail 9B of FIG. 9A. The measurement line 910 can comprise a knot 913 at the first end 915. The knot 913 can be received within and secured within an opening 918 defined in the panel 110. The opening 918 can be a keyhole slot, in which a first end of the opening 918 is larger in at least one direction than a second end of the opening 918, as broadly defined. As shown, the keyhole slot can define a T-shape, the geometric elements of which can be oriented as shown or can be aligned with the ends 115,116 (116 shown in FIG. 9A) and/or the side ends 117,118 (117 shown in FIG. 9A).

The dimensions of the keyhole slot can be set to hold the measurement line 910 firmly but not so firmly that the measurement line 910 cannot be quickly removed with a quick tug. By making the measurement line 910 easily removable, the measurement line 910 can be removed from the panel 110 after installation of the device 100, thereby removing a path along with a vine could otherwise grow towards the panel 110 and, additionally, allowing the measurement line 910 to be used during installation of the next device 100.

A method of installing the vine growth prevention device 100 can comprise assembling one or more of the fasteners 190 to the vine growth prevention panel 110. More specifically, the method can comprise extending the tail 520 of each fastener through the first opening 180 defined in the panel 110. The method can comprise wrapping the fastener 190 around the guy wire 85 or other climbing structure 80. The method can comprise extending the fastener 190 through the second opening 180 of two openings 180 defined in the panel 110 for the corresponding fastener location. The method can comprise engaging the tail 520 of the fastener 190 with the head 510 thereof.

Again, the method can comprise placing an end of the panel 110 such as the first side end 117 of the panel 110 in contact with the climbing structure 80 such as the guy wire 85 shown. The method can comprise securing the panel 110 to the climbing structure 80 with the fastener 190. The method can comprise tightening the fastener 190 sufficiently so that the panel 110 does not slide down the climbing structure 80 once placed at the desired height. The method can comprise trimming the fastener 190 to remove any excessive remaining portion of the tail 520 to prevent a vine from finding such portion and trying to climb it.

The method can comprise forming a knot in the measurement line 910. The method can comprise securing a length 970 of the measurement line 910 to the panel 110. More specifically, the method can comprise positioning a lowermost portion of the panel 110 a predetermined minimum distance from the ground. The method can comprise removing the measurement line after securing the panel 110 to the guy wire 85 or other climbing structure 80.

FIG. 9C is a side elevation view of the vine growth prevention device 100 of FIG. 1A after installation on the guy wire 85 of FIG. 1A, which can be a first guy wire 85a, and additionally secured to a second guy wire 85b, which can be a lower guy wire. The method can comprise, such as when the multiple guy wires 85a,b exist in a vertical plane, securing the panel 110 to the second guy wire 85b with the fastener 190, which can occur after securing the panel 110 to the first guy wire 85a. Each of the guys wires 85a,b—and, more generally, climbing structures 80a,b, which can comprise the guys wires 85a,b—can lie in the same plane, which can be oriented in a generally vertical direction. In some aspects, as again shown, multiple sets or pairs of the openings 180 can extend in a direction perpendicular to a direction in which the panel 110 is attached to the first guy wire 85a. Each of the guy wires 85a,b can be secured in the ground 940 with the anchor 950 and can be angled with the horizontal by a respective angle 907a,b. The angles 907a,b need not be the same and will typically not be the same.

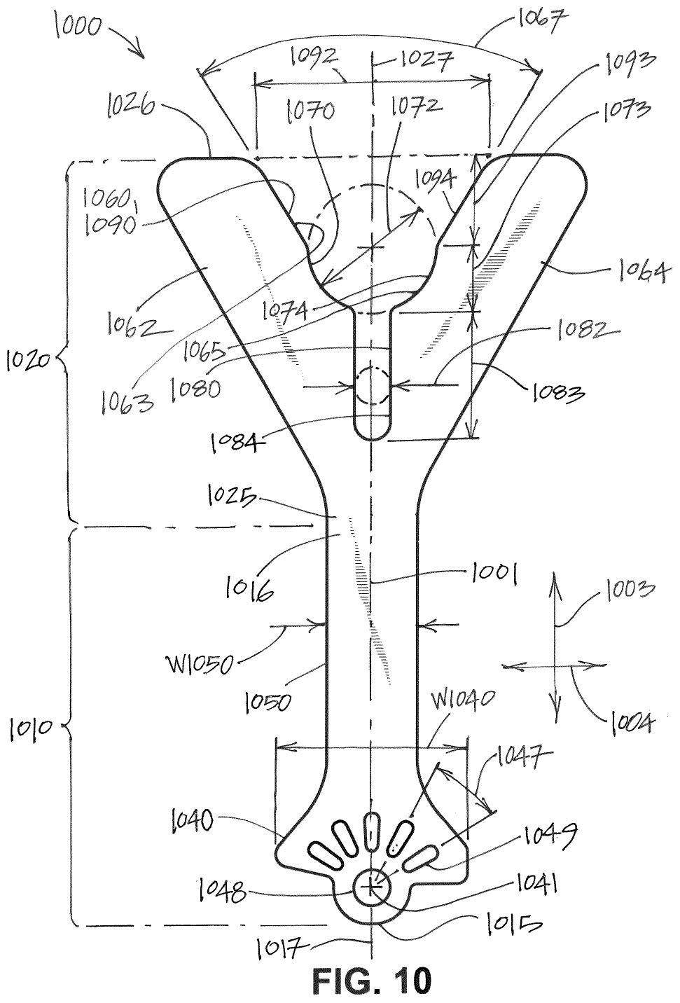

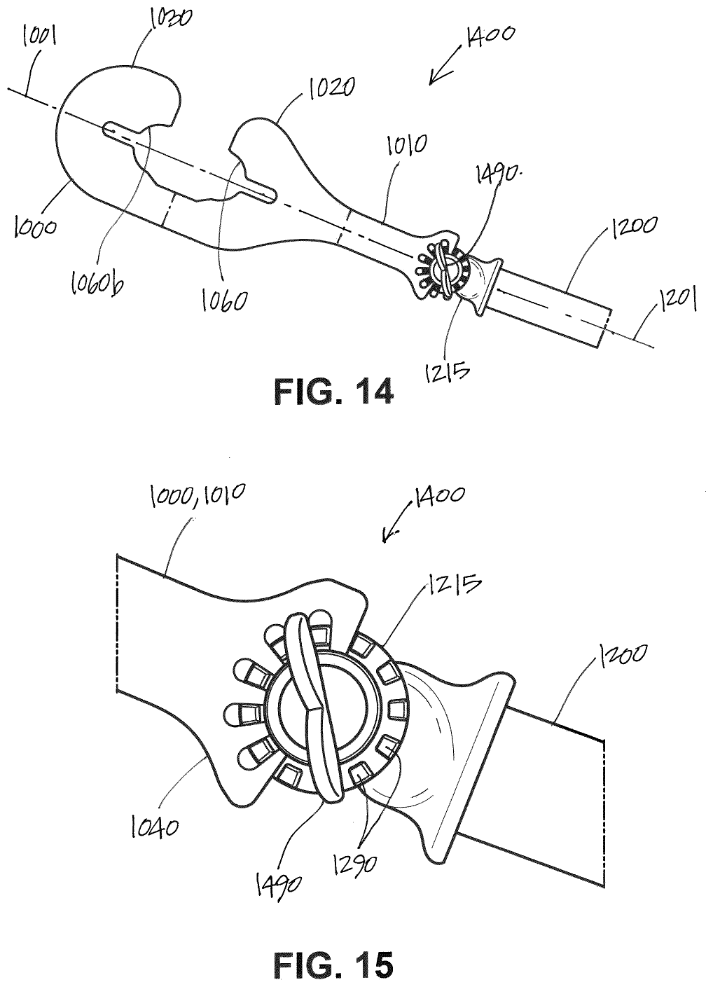

FIG. 10 is a top plan view of a vine removal tool or tool 1000 in accordance with one aspect of the current disclosure. The vine removal tool 1000, which can form part of a vine removal system 1400 (shown in FIG. 14), can define an axis or centerline 1001. The vine removal tool 1000 can comprise a first portion 1010, which can define a first end or mounting end 1015 and a second end 1016. The vine removal tool 1000 can comprise a second portion 1020, which can extend from the first portion 1010 and can define a first end 1025 and a second end or working end 1026. The vine removal tool 1000 can define a longitudinal direction 1003 and a transverse direction 1004. In some aspects, as shown, the second end 1016 of the first portion 1010 and the first end 1025 of the second portion 1020 can be monolithically formed as part of the vine removal tool 1000. In other aspects, the first portion 1010 and the second portion 1020 can be formed as separate parts, and thus the second end 1016 and the first end 1025 can be separate structures and can be configured to be joined only upon assembly of the vine removal tool 1000. In some aspects, the first portion 1010 and, more generally, the vine removal tool 1000 can be lengthened by simply swapping out the original first portion 1010 for a longer first portion 1010.

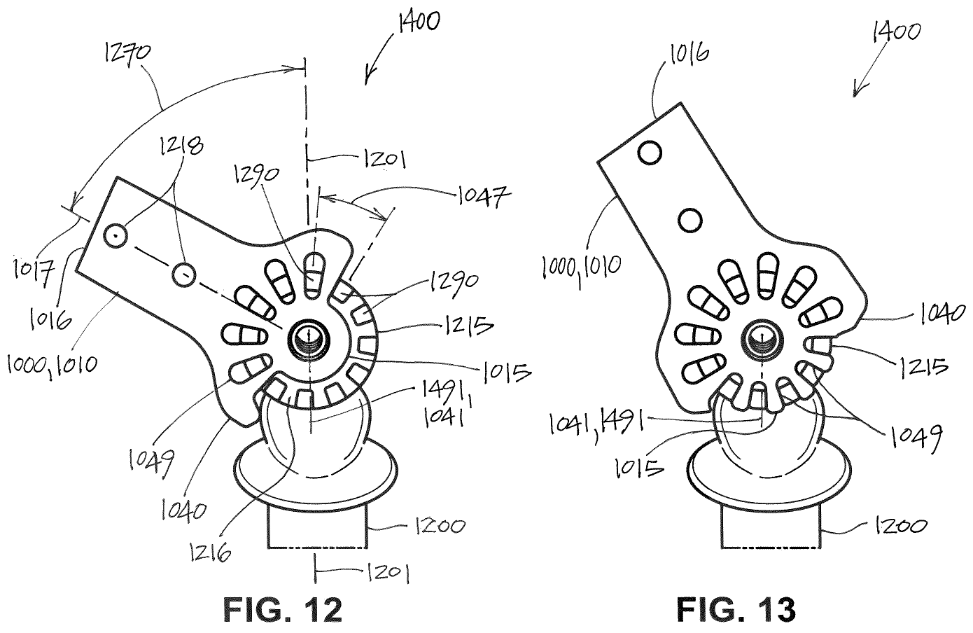

The first portion 1010 can comprise an adapter 1040, which can be configured to be secured to an extension member 1200 (shown in FIG. 12). The adapter 1040 can define a mounting bore or mounting opening or opening 1048, which can define a tool rotation axis 1041. The adapter 1040 can define one or more indexing bores or indexing openings or openings 1049, adjacent openings 1049 of which can be sized to match a corresponding structure of the extension member 1200 and can be spaced apart by an angular distance 1047 matching an angular distance between corresponding structures of the extension member 1200. As shown, the angular distance 1047 can be 30 degrees. The first portion 1010 can comprise a neck 1050, which can extend from the adapter 1040 to the second end 1016. The neck 1050 can provide a structure for a user of the vine removal tool 1000 to grip the vine removal tool 1000 with one or both hands. Even without the extension member 1200, the neck 1050 can extend the working end 1026 of the second portion 1020 of the vine removal tool 1000 further away from the user so that the user need not be as close to the climbing structure 80 (shown in FIG. 1A) during use of the vine removal tool 1000. In some aspects, any risk of using the extension member 1200 or a ladder to reach higher on the climbing structure 80 can be avoided by using the vine removal tool 1000 by itself—with the neck 1050 extended even further as desired. The neck 1050 can, as desired, be formed into an ergonomic shape. A width W1040 of the mounting end 1015 of the first portion 1010 in a transverse direction 1004 can be greater than a width W1050 of the neck 1050.

The vine removal tool 1000 and, more specifically, the second portion 1020 thereof can define a notch 1060. The notch 1060 can comprise a first notch 1070, which can define a first diameter or maximum width 1072, including in the transverse direction 1004, a first radius (not shown but measuring half the diameter, at least where the diameter is measurable and constant, which it can be but need not be), a first depth 1073 in the longitudinal direction, and a first notch edge or first edge 1074. The notch 1060 can comprise a second notch 1080, which can define a second diameter or maximum width 1082, including in the transverse direction 1004, a second radius (not shown but measuring half the diameter, at least where the diameter is measurable and constant, which it can be but need not be), a second depth 1083 in the longitudinal direction, and a second notch edge or second edge 1084. The notch 1060 can comprise a third notch 1090, which can define a third diameter or maximum width 1092, including in the transverse direction 1004, a third radius (not shown but measuring half the diameter, at least where the diameter is measurable and constant, which it can be but need not be), a third depth 1093 in the longitudinal direction, and a third notch edge or edge 1094. Any edge or portion thereof that is straight such as, for example and without limitation, the third edge 1094 can define an infinite radius.

A centerline 1027 of each of the first notch 1070 and the second notch 1080 and the third notch 1090 and, more generally, the notch 1060, can be aligned with a centerline 1017 of the mounting end 1015. The working end 1026 can define a Y-shape comprising a first leg 1062 and a second leg 1064. The second leg 1064 can be angled with respect to the first leg 1062—or, alternatively, respective inside edges 1063,1065 of each of the first leg 1062 and the second leg 1064 can be separated—by an angle 1067. In some aspects, the angle 1067 can measure less than 180 degrees. In some aspects, the angle 1067 can measure less than or equal to 150 degrees. In some aspects, the angle 1067 can measure less than or equal to 120 degrees. As shown, the angle 1067 can measure 120 degrees. The third diameter or maximum width 1092, which can be a width in the transverse direction 1004 of an entrance of the vine removal tool 1000, can be measured between the inside edges 1063,1065 at their intersection with the working end 1026 of the second portion 1020.

The second notch 1080 can intersect and be defined in at least a portion of the first notch 1070. The first notch 1070 can intersect and be defined in at least a portion of the third notch 1090. The first diameter or width 1072 can be greater than the second diameter or width 1082 and, similarly, the first radius can be greater than the second radius. The third diameter or width 1092 can be greater than the first diameter 1072 and, similarly, the third radius can be greater than the first radius.

In some aspects, the first diameter 1072 can be about equal to a diameter 1812 (shown in FIG. 18) of the wire guard 1810 (shown in FIG. 18), which can be one form of the climbing structure 80. In some aspects, the first diameter 1072 can be equal to or greater than the diameter 1812. The first notch 1070 can thus be configured to receive the wire guard 1810 therein. In some aspects, as shown, the first depth 1073 can be less than the first diameter 1072. In some aspects, the first depth 1073 can be equal to the first diameter 1072. In some aspects, the first depth 1073 can be greater than the first diameter 1072.

In some aspects, the second diameter 1082 can be about equal to the diameter 82 (shown in FIG. 1A) of the wire or other climbing structure 80 (shown in FIG. 1A). In some aspects, the second diameter 1082 can be equal to or greater than the diameter 82. The second notch 1080 can thus be configured to receive the guy wire 85 therein. In some aspects, as shown, the second depth 1083 can be greater than the second diameter 1082 to help ensure that both sides of the second notch contact sides of the guy wire 85, even when an angle 2007 (shown in FIG. 20) between the vine removal tool 1000 and the axis 81 of the climbing structure 80, e.g., the guy wire 85 is much less than 90 degrees and even approaching 30 degrees or less. In some aspects, the second depth 1083 can be at least four times the second diameter 1082. In some aspects, the second depth 1083 can be equal to the second diameter 1082. In some aspects, the second depth 1083 can be less than the second diameter 1082.

Each of or any of the notches 1070,1080,1090 and, more generally, the notch 1060, can help locate the climbing structure 80 or align the vine removal tool 1000 with the climbing structure 80 and can be configured to clean the climbing structure 80 by removing vines therefrom. More specifically, the first notch 1070 and, more specifically, the edge 1074 thereof can be offset in an axial direction from the third notch 1090 and can be configured to clean the wire guard 1810 by removing vines therefrom. The third notch 1090 can help locate the guy wire 85 or align the vine removal tool 1000 with the guy wire 85. The first notch 1070 and, more specifically, the edge 1074 thereof can be offset in an axial direction from the third notch 1090 and can be configured to clean the wire guard 1810 by removing vines therefrom. The second notch 1080 and, more specifically, the edge 1084 thereof can be offset in an axial direction from the first notch 1070 and can be configured to clean the guy wire 85 by removing vines therefrom.

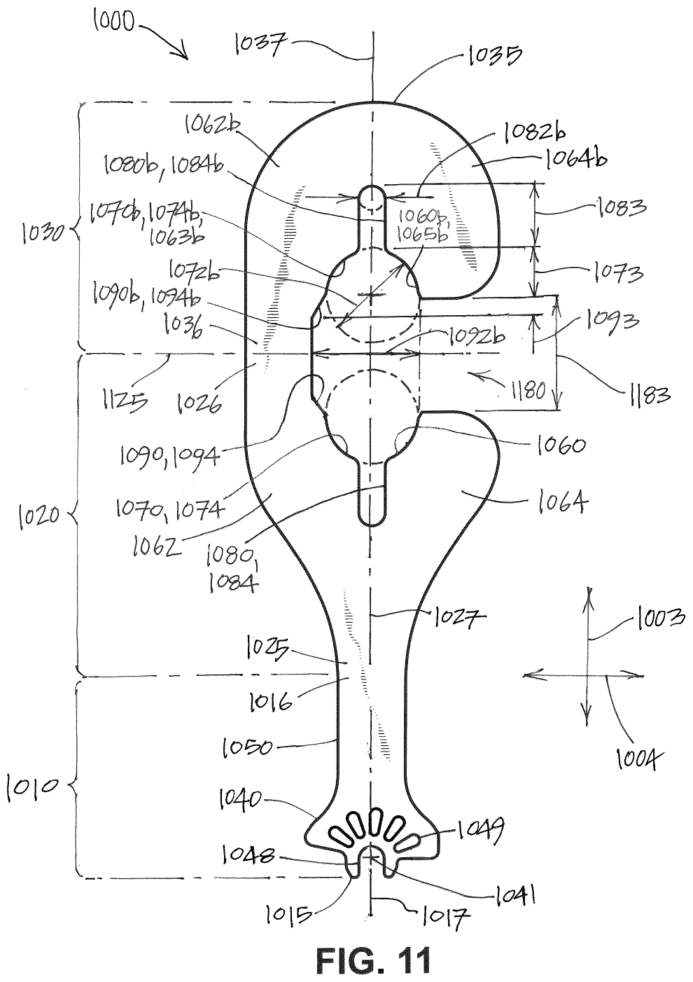

FIG. 11 is a top plan view of the vine removal tool 1000 in accordance with another aspect of the current disclosure. The vine removal tool 1000 can further comprise a third portion 1030, which can define a first end 1035 and a second end or working end 1036. In some aspects, as shown, the second end 1026 of the second portion 1020 and the second end 1036 of the third portion 1030 can be monolithically formed as part of the vine removal tool 1000. In other aspects, the second portion 1020 and the third portion 1030 can be formed as separate parts, and thus the second end 1016 and the first end 1025 can be separate structures and can be configured to be joined only upon assembly of the vine removal tool 1000.

As shown, the mounting bore or mounting opening or opening 1048 of the adapter 1040 can be or can define a notch, which can extend from and be open to the first end 1015 of the first portion 1010 of the vine removal tool 1000. The first portion 1010 can comprise the neck 1050, which can extend from the adapter 1040 to the second end 1016.

The vine removal tool 1000 and, more specifically, the third portion 1030 thereof can define a notch 1060b. The notch 1060b can comprise a first notch 1070b (or, alternatively, a third or fourth notch depending on whether the third notch 1090 is present, which applies also to other features of the first notch 1070b disclosed herein), which can define one or more characteristics corresponding to characteristics of the first notch 1070, namely, a first diameter or maximum width 1072b corresponding to the first diameter or maximum width 1072, a first radius corresponding to the first radius of the first notch 1070, a first depth 1073b corresponding to the depth 1073, and a first notch edge or first edge 1074b corresponding to the first notch edge or first edge 1074. The notch 1060b can define a second notch 1080b (or, alternatively, a fourth or fifth notch depending on whether the third notch 1090 is present, which applies also to other features of the second notch 1080b disclosed herein), which can define one or more characteristics corresponding to characteristics of the second notch 1080, namely, a second diameter or maximum width 1082b corresponding to the second diameter or maximum width 1082, a second radius corresponding to the second radius of the second notch 1080, a second depth 1083b corresponding to the second depth 1083, and a second notch edge or edge 1084b corresponding to the second notch edge or second edge 1084. The notch 1060b can comprise a third notch 1090b (or, alternatively, a fifth or sixth notch depending on whether the third notch 1090 is present, which applies also to other features of the third notch 1090b disclosed herein), which can define a third diameter or maximum width 1092b corresponding to the third diameter or maximum width 1092, a third radius corresponding to the third radius of the third notch 1090, a third depth 1093b corresponding to the third depth 1093, and a notch edge or edge 1094b corresponding to the third notch edge or third edge 1094.

A centerline 1037 of each of the first notch 1070b and the second notch 1080b and the third notch 1090b and, more generally, the notch 1060b can be aligned with the centerline 1027 of the notch 1060 and/or the centerline 1017 of the mounting end 1015. The working end 1036 can define a Y-shape comprising a first leg 1062b and a second leg 1064b. In some aspects, geometry of the third portion 1030 of the vine removal tool can essentially be mirrored from geometry of the second portion 1020, and the mirror line can be a dividing line 1125 separating the second portion 1020 and the third portion 1030. The third diameter or maximum width 1092b, which can be a width in the transverse direction 1004 of an entrance of the vine removal tool 1000, can be measured between the inside edges 1063b,1065b at their intersection with the working end 1036 of the third portion 1030. Characteristics of the third portion 1030 of the vine removal tool 1000 can otherwise be as described for the corresponding features of the second portion 1020.

Each of or any of the notches 1070b,1080b,1090b or an opening 1180 defined between the second portion 1020 and the third portion 1030 opposite from, with respect to the centerlines 1027,1037, where the second portion 1020 and the third portion 1030 are connected, can help locate the climbing structure 80 or align the vine removal tool 1000 with the climbing structure 80 and can be configured to clean the climbing structure 80 by removing vines therefrom. The opening 1180 can define an open dimension 1183, which can be measured in the longitudinal direction 1003. In some aspects, the open dimension 1183 can measure at least the diameter 1812 of the wire guard 1810 or the diameter 1072 generally intended to accommodate the wire guard 1810. In some aspects, the open dimension 1183 can measure at least 1.2 times the diameter 1812 or the diameter 1072. Each of or any of the notches 1070b,1080b,1090b and, more generally, the notch 1060b of the third portion 1030 can face the notches 1070,1080,1090 and, more generally, the notch 1060 of the second portion 1020. Each of or any of the notches 1070b,1080b,1090b and, more generally, the notch 1060b can be in communication with the opening 1180, which broadly defined can comprise the notches 1070,1080,1090 and the notches 1070b,1080b,1090b. A side wall 1150 can extend between and can be defined in each of the second portion 1020 and the third portion 1030. The side wall 1150 can help redirect the climbing structure 80 into either of the notch 1060 and the notch 1060b.

In some aspects, the vine removal tool 1000, the materials and manufacturing of which are described in further detail below, can define a constant thickness throughout. In some aspects, a thickness of the vine removal tool 1000 can vary. For example and without limitation, the vine removal tool 1000 can comprise stiffening features (e.g., ribs extending from a surface of the vine removal tool 1000) and/or separate inserts, which can be formed from a different (e.g., a harder) material and permanently joined or removable and replaceable to the surrounding material of the vine removal tool 1000 for contacting and cleaning the climbing structure 80. More specifically, for example and without limitation, an aluminum or steel insert could be assembled to a portion of the tool that is otherwise formed from a non-metallic material to prevent or reduce wear and/or to more quickly cut the vine growth sought to be removed from the guy wire 85. The vine removal tool 1000 can be configured to resist catastrophic bending or buckling thereof under the forces able to be applied to the tool by a user under normal use.

The vine removal tool 1000 or any portion thereof can be formed from any one or more of various materials such as, for example and without limitation, a metallic material, a polymeric material, and/or a composite material. Metallic materials can include, for example and without limitation, aluminum. Polymeric materials can include, for example and without limitation, polyethylene (e.g., HDPE) and acetyl. Composite materials can include, for example and without limitation, a glass-filled or glass-reinforced polymer, which can also be considered polymeric materials. In some aspects, the first portion 1010 of the vine removal tool 1000 can comprise or be formed from aluminum, steel, or another material with a higher flexural and tensile stiffness than a material from which the second portion 1020 and/or third portion 1030 is formed. Such use of a stronger material can, as desired, reduce or prevent bending at the connection point of the vine removal tool 1000 with the extension member 1200 and tensile failure when pulling down on the vine removal tool 1000, especially in a vertical direction using the extension member 1200. In some aspects, a thickness of the material forming the vine removal tool 1000 can be increased and/or reinforcement added to the geometry of the vine removal tool 1000 to reduce the risk of bending and tensile failure.

FIG. 12 is a side perspective view of a first portion 1010 of the vine removal tool 1000 at least partially assembled to an extension member 1200, the first portion 1010 shown in accordance with one aspect of the current disclosure. The first portion 1010 and the mounting end 1015 thereof can be secured to the extension member 1200 with a fastener 1490 (removed for clarity but shown in FIG. 14), which can be installed along a mounting axis 1491. More specifically, one or more protrusions 1290 of a first end 1215 of the extension member 1200 can extend from a surrounding surface 1216 of the first end 1215, against which the vine removal tool 1000 can mate, and the one or more protrusions 1290 can be received within the indexing openings 1049. In some aspects, as shown, the first end 1215 can define a plurality of protrusions 1290 spaced apart by the angular distance 1047 and, more specifically, a set of 12 protrusions 1290, with adjacent protrusions 1290 spaced apart at 30 degrees. In such aspects and other aspects, a rotational position of the first portion 1010 and, more generally, the vine removal tool 1000 can be adjustable. More specifically, an angle 1270 defined between the centerline 1017 and an axis 1201 of the extension member 1200 can be adjustable by rotation of the vine removal tool 1000 with respect to the extension member 1200. Installation of the fastener 1490, which can prevent movement of the vine removal tool 1000 with respect to the extension member 1200 along the axis 1491, can also maintain the angle 1270. As shown, the first portion 1010 can comprise mounting holes 1218, through which a second portion 1020 of the vine removal tool 1000 can be secured to the first portion 1010. In some aspects, as previously described, the vine removal tool 1000 and, more specifically, the first portion 1010 and the second portion 1020 can be formed as one piece.

FIG. 13 is a side perspective view of the first portion 1010 of the vine removal tool 1000 at least partially assembled to an extension member 1200, the first portion 1010 being in accordance with another aspect of the current disclosure. In some aspects, as shown, the vine removal tool 1000 can define additional indexing openings 1049, which can extend as much as 360 degrees around the axes 1041,1491 for a larger range of adjustment. As also shown, one or more of the indexing openings 1049 can be open on one end and, more specifically, an outer end.

FIG. 14 is a side perspective view of the vine removal tool 1000 of FIG. 11 assembled to the extension member 1200 of FIG. 12, and FIG. 15 is a detail side perspective view of the assembly of FIG. 14. The extension member 1200 can be a lineman's pole or “hot stick,” referred to as such because it is typically formed as a long stick or pole from a non-conductive material and can safely contact a high-voltage live or “hot” electrical line without endangering a user. As shown, the fastener 1490 need not require tools for tightening or loosening. More specifically, the fastener 1490 can comprise a wing nut or wing stud for adjustment of a rotational position of the vine removal tool 1000 or installation and/or replacement of the vine removal tool 1000 without tools.

A method of assembling the vine removal tool 1000 can comprise aligning an axis of the first end 1215 of the extension member, the mounting opening 1048 of the vine removal tool 1000, and the axis of the fastener 1490. The method can comprise rotating the vine removal tool 1000 with respect to the extension member 1200 to achieve a desired rotational position of the vine removal tool 1000. The method can comprise tightening the fastener 1490 to again prevent rotation of the vine removal tool 1000 with respect to the extension member 1200.

A method of using the vine removal tool 1000 can comprise adjusting a rotational position of the tool with respect to a handle such as, for example and without limitation, the extension member 1200 from a first attachment angle to a second attachment angle. More specifically, the method can comprise loosening the fastener 1490 to allow rotation of the vine removal tool 1000 with respect to the extension member 1200. The method can comprise rotating the vine removal tool 1000 with respect to the extension member 1200 from a first rotational position to a second rotational position angled with respect to the first rotational position. The method can comprise tightening the fastener 1490 to again prevent rotation of the vine removal tool 1000 with respect to the extension member 1200.

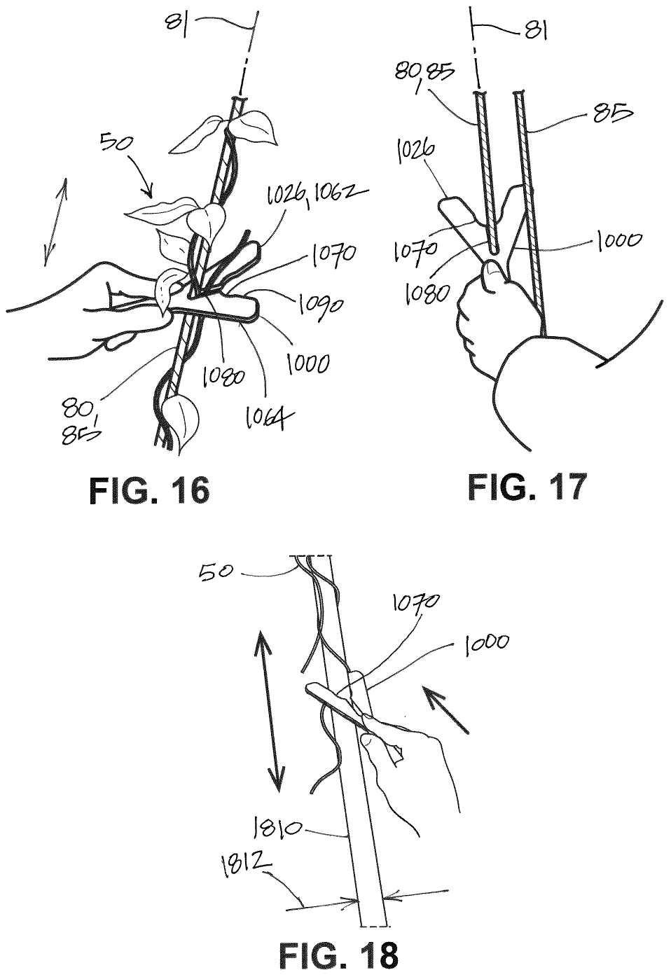

FIG. 16 is a side top perspective view and FIG. 17 is a front top perspective view of a user removing a vine from the guy wire 85 of FIG. 1A with the vine removal tool 1000 of FIG. 10. A method of using the vine removal tool 1000 can comprise aligning one of the first notch 1070 and the second notch 1080 with the climbing structure 80, e.g., the guy wire 85 shown. Especially when the vine growth 50 is thick, one or both of the first notch and the third notch 1090 can facilitate the user locating the guy wire 85, which can be at least partially hidden. The method can further comprise engaging the vine removal tool 1000 with the guy wire 85 by, as shown by the double-sided arrow, sliding the vine removal tool 1000 up and down the guy wire 85 with respect to the axis 81 while generally maintaining contact between the vine removal tool 1000 and the guy wire 85. As shown in FIG. 17, even guy wires 85 in close proximity to each other can be cleaned with the vine removal tool 1000 due to its relatively compact size, in some aspects being roughly as wide as a human hand or, at most, 5 inches or about 5 inches across.

FIG. 18 is a side bottom perspective view of the user removing a vine from the wire guard 1810 surrounding the wire of FIG. 1A with the vine removal tool 1000 of FIG. 10. The wire guard 1810 can define the diameter 1812. In some aspects, the diameter 1812 can measure about one inch. In some aspects, the diameter 1812 can measure about 1.5 inches. In some aspects, the diameter 1812 can measure 2 inches or less. In some aspects, the wire guard 1810 can define a length of up to 8 feet or more. The wire guard 1810 can be formed from any one of a variety of materials including a polymeric material such as, for example and without limitation, polyethylene. The wire guard 1810 can be secured with fasteners such as, for example and without limitation, threaded fasteners, straps, and/or other fasteners.

A method of using the vine removal tool 1000 can comprise aligning the first notch 1070 with the climbing structure 80, e.g., the wire guard 1810 shown. The method can further comprise engaging the vine removal tool 1000 with the wire guard 1810 by, as shown by the double-sided arrow, sliding the vine removal tool 1000 up and down the wire guard 1810 with respect to the axis 81 while generally maintaining contact between the vine removal tool 1000 and the wire guard 1810. In some aspects, the vine removal tool 1000 can be especially effective when pushing the vine up the guy wire 85 and snapping the vine by the scraping or abrasion force applied by the vine removal tool 1000 and/or a tensile failure in the vine caused by a stretching or tensile force applied by the vine removal tool 1000. In some aspects, a force of between 15 and 100 pounds of force can be applied along the longitudinal direction 103 in either a pushing or pulling direction, appropriate for the vine removal tool 1000 being used.

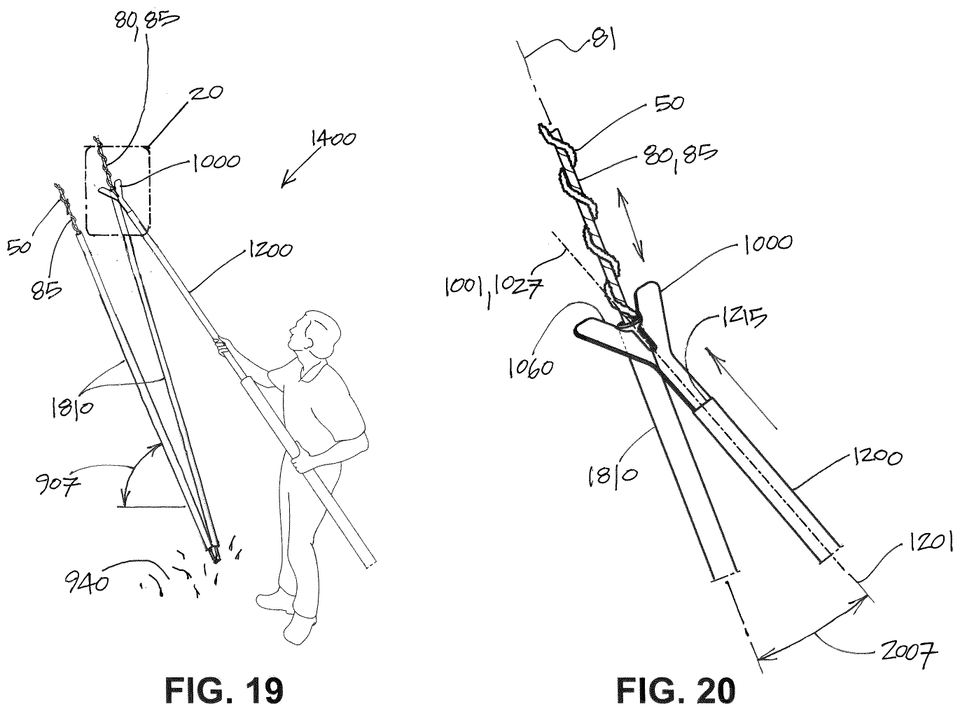

FIG. 19 is a side top perspective view of the user holding a vine removal system 1400 and engaging the climbing structure 80, e.g., the guy wire 85 shown, with the vine removal system 1400. Again, the vine removal system 1400 can comprise the vine removal tool 1000 and the extension member 1200. The number of guy wires, the angles 907 of the guy wires 85 and the resulting positioning of the bases of the guy wires 85, the length of the wire guards 1810, the height of the vine growth 50 on the guy wires 85 (especially when the vine growth 50 has grown higher than 8 feet up a guy wire 85), the presence of surrounding vegetation and especially vine growth 50 (even if only near the ground 940), the unevenness and unpredictability of the terrain, and/or other factors can make use of the extension member 1200 additionally helpful.

The method of using the vine removal system 1400 can comprise aligning the vine removal tool 1000 with the climbing structure 80, e.g., the guy wire 85 shown, while holding the extension member 1200. The method can comprise engaging the vine removal tool 1000 while holding the extension member 1200. When pushing the vine removal tool 1000 up the guy wire 85, including when using the vine removal tool 1000 shown in FIG. 10, it can be beneficial for a user to stand, as shown, outside the guy wire 85. When pulling the vine removal tool 1000, including when using the vine removal tool 1000 shown in FIG. 11, it can be beneficial to stand under the guy wire 85 and pull the vine removal tool 1000 by pulling extension member 1200 down toward the ground attachment point. In some aspects, a user can also collapse the extension member 1200, which can comprise and typically does comprise a telescoping feature, to facilitate such pulling and to permit movement of the vine removal tool 1000 without the user needing to move the user's position or hit the ground 940 with a second end of the extension member 1200 that is opposite from the first end 1215 (shown in FIG. 14).

FIG. 20 is a detail view of the vine removal system 1400 of FIG. 19 showing the vine removal tool 1000 of FIG. 10 engaged with the guy wire 85 of FIG. 1A and taken from detail 20 of FIG. 19. The method of using the vine removal system 1400 can comprise pushing the vine removal tool 1000 and, more specifically, the notch 1060 and edges defined therein against either of the guy wire 85 and the wire guard 1810 to remove vine growth 50 from the corresponding climbing structure 80. In some aspects, one or more edges defined by the notch 1060 (shown in FIG. 11) or the notch 1060 (shown in FIG. 11) can cut the vine using a shearing action, as the blades of a pair of pruning shears would cut a vine. In the vine removal system 1400, however, the guy wire 85 or the wire guard 1810 can, by analogy, correspond to the first blade of the pair of pruning shear blades, albeit a very “dull” first blade without any point that depends largely on friction between the vine and the guy wire 85 or the wire guard 1810; and the edge (e.g., 1063 and 1065) of the vine removal tool 1000 in contact with the guy wire 85 or the wire guard 1810 or, more directly, the vine itself, can correspond to the second bald of the pair of pruning shear blades. As shown, the vine removal tool 1000 can be coupled to the extension member 1200 without the adjustability described above and shown in FIGS. 14 and 15.

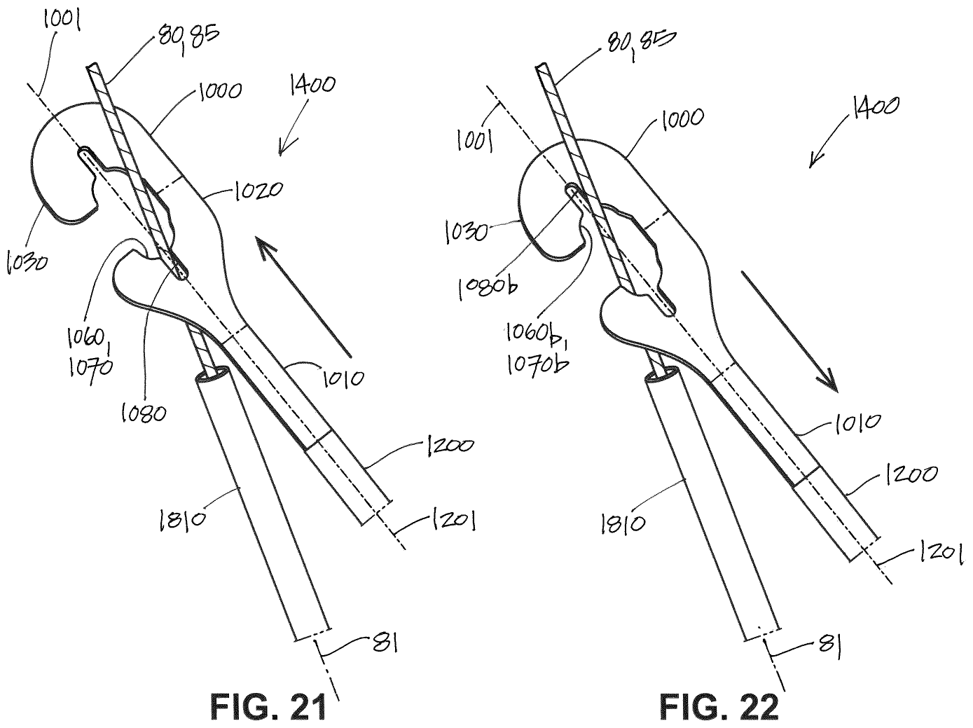

FIG. 21 is a detail view of the vine removal system 1400 comprising the vine removal tool 1000 of FIG. 11 and being pushed against the guy wire 85 of FIG. 1A in a direction away from the user taken from detail 20 of FIG. 19. In some aspects, as shown, by pushing the vine removal tool 1000 towards the guy wire 85, the user can contact and scrape a front end or near end of the guy wire 85 with the notch 1060 and, more specifically, the second notch 1080 of the vine removal tool 1000. In some aspects, by pushing the vine removal tool 1000 towards the wire guard 1810, the user can contact and scrape a front end or near end of the wire guard 1810 with the notch 1060 and, more specifically, the first notch 1070 of the vine removal tool 1000.

FIG. 22 is a detail view of the vine removal device of FIG. 21 being pulled against the wire of FIG. 1A in a direction towards from the user taken from detail 20 of FIG. 19. In some aspects, as shown, by pulling the vine removal tool 1000 towards the guy wire 85, the user can contact and scrape a rear end or far end of the guy wire 85 with the notch 1060b and, more specifically, the second notch 1080b of the vine removal tool 1000. In some aspects, by pushing the vine removal tool 1000 towards the wire guard 1810, the user can contact and scrape a rear end or far end of the wire guard 1810 with the notch 1060b and, more specifically, the first notch 1070b of the vine removal tool 1000.

The method of using the vine removal system 1400 and/or the vine removal tool 1000 can comprise scraping the vine growth 50 from the guy wire 85 or wire guard 1810 or other climbing structure 80 prior to installation of the vine growth prevention device 100. The proximal end of the tool that mates to the lineman's pole (also called a hotstick) can be rotated with indexing features if a particular angle is needed. The tool may also be used without the line pole as a hand tool when guy wires need to be cleared up to 8 feet maximum.

Benefits of the vine growth prevention device 100 can comprise:
Prevention of vine growth climbing up the guy wire 85;
Ability to last two years in all-weather conditions, including wind, rain, ice, and snow;
No interference with the guy wires 85 or their use;
Installation time less than or equal to two minutes or less or, in some aspects, three minutes or less;
Ability to remain in position once installed;
Ability to work with either a guy wire 85 or a wire guard 1810 or even multiple guy wires 85;
Compact design;
Intuitive and simple to use;
Low material cost;
Environmental benefit of not having to use herbicides to kill vine growth; and
Ability to be recycled after use.

Benefits of the vine removal system 1400 can comprise:
Effective removal of vine growth climbing up the guy wire 85, even at significant heights not safely and practically reachable;
No interference with the guy wires 85 or their use;
Ability to work with either a guy wire 85 or a wire guard 1810;
Compact design;
Intuitive and simple to use;
Low material cost;
Environmental benefit of not having to use herbicides to kill vine growth; and
Ability to be recycled after use.

In some aspects, the various components can be formed from materials that are corrosion-resistant or replaceable for serviceability. In some aspects, a component of the vine growth prevention device 100 or vine removal system 1400 can comprise or can be solely formed from a material or materials that are conductive of electricity, especially is such a component will not come in contact with any utility lines (e.g., power lines) themselves. In some aspects, a component of the vine growth prevention device 100 or vine removal system 1400 can comprise or can be solely formed from a material or materials that are non-conductive of electricity. More specifically, in some aspects, a volume resistivity of the material or materials can measure between 10¹¹ and 10¹⁹ Ω·cm. In some aspects, a surface resistivity of the material or materials can measure at least 1012 Ω·cm².

The various components of the vine growth prevention device 100 or the vine removal system 1400 can be formed from any one or more of a variety of manufacturing processes. For example and without limitation, the panel 110 and the vine removal tool 1000 can be fabricated using subtractive manufacturing processes such as machining, forging, stamping, and cutting (e.g., by die cutting, laser cutting, or water jet cutting); additive manufacturing processes such as three dimensional printing; and any other forming and assembly processes such as bending, welding, and fastening. In some aspects, the vine removal tool 1000 or portions thereof can be monolithically formed from one piece in one or more sheet metal forming process. In some aspects, the vine removal tool 1000 can be monolithically formed from one piece in a molding process, which can allow for more complex geometries and lighter weight.

One should note that conditional language, such as, among others, “can,” “could,” “might,” or “may,” unless expressly stated otherwise, or otherwise understood within the context as used, is generally intended to convey that certain aspects include, while other aspects do not include, certain features, elements, and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

That which is claimed is:

1. A vine growth prevention device comprising:
a panel defining a width in a transverse direction, a length in a longitudinal direction, and one or more openings, the panel being planar in an installed and unstressed condition and formed from a material defining a flexural strength of 5 to 50 ksi, inclusive, the one or more openings defined in the panel between a first side end and a second side end of the panel; and
a fastener configured to secure the panel to a guy wire at and through each of the one or more openings and at a position between the first side end and the second side end.

2. The vine growth prevention device of claim 1, wherein:
the one or more openings comprise at least two pairs of openings, a first pair of the at least two pairs of openings spaced apart from a second pair of the at least two pairs of openings in a longitudinal direction of the panel;
the first pair of the at least two pairs of openings and the second pair of the at least two pairs of openings offset from the first side end of the panel in a transverse direction by an edge offset distance; and
the first pair of the at least two pairs of openings spaced apart in a transverse direction of the panel and the second pair of the at least two pairs of openings spaced apart in the transverse direction of the panel.

3. The vine growth prevention device of claim 1, wherein the panel is formed monolithically.

4. The vine growth prevention device of claim 1, wherein the panel is formed from a material that is at least one of polymeric, non-conductive of electricity, and configured to not allow passage of ultraviolet wavelengths.

5. The vine growth prevention device of claim 1, wherein the width of the panel is equal to or greater than than L_{V}, where:
$${L}_{V} = {( \frac{δ \cdot 3 \cdot E \cdot π {d}^{4}}{64 \cdot mg \cdot sin θ} )}^{1 / 3} ,$$
and
where:
δ is the deflection of the vine,
E is Young's modulus,
d is the diameter of the vine,
m is the mass of the vine,
g is the acceleration of gravity, and
θ is the angle between the guy wire and a horizontal direction.

6. The vine growth prevention device of claim 1, wherein a width of the panel measures at least 12 inches and a length of the panel measures at least 2.5 times the width.

7. The vine growth prevention device of claim 1, wherein a width of the panel measures at least 23.75 inches and a length of the panel measures at least as long as the width.

8. The vine growth prevention device of claim 1, further comprising a measurement line.

9. The vine growth prevention device of claim 8, wherein the measurement line can be installed or removed from the panel without tools and without modifying the measurement line.

10. A method of assembling the vine growth prevention device of claim 1, comprising:
placing a first side end of the panel in contact with a guy wire extending from the ground to an upright structure; and
securing the panel to the guy wire with a fastener, the fastener extending through at least an opening of the one or more openings.

11. The method of claim 10, further comprising removably coupling a measurement line to the panel, the measurement line measuring at least three feet in length as installed.

12. The method of claim 10, further comprising stacking multiple panels in at least one of a longitudinal direction and a transverse direction to simulate the presence of a larger single panel.

13. A vine removal tool comprising:
a first portion defining a mounting end; and
a second portion defining a working end, the working end defining:
a first notch defining a first radius; and
a second notch intersecting the first notch and defining a second radius, the first radius being greater than the second radius.

14. The vine removal tool of claim 13, further comprising a third portion comprising:
a third notch defining a third radius; and
a fourth notch intersecting the third notch and defining a fourth radius, the third radius being greater than the fourth radius;
wherein each of the first notch and the second notch face each of the third notch and the fourth notch.

15. The vine removal tool of claim 13, wherein:
one of a) two times the first radius and b) a width of the first notch is configured to be equal to or greater than one of c) one inch and d) a diameter of a standard guy wire guard; and
one of a) two times the second radius and b) a width of the second notch is configured to be equal to or greater than one of c) ⅜ inch and d) a diameter of a standard guy wire.

16. The vine removal tool of claim 15, wherein a maximum width of an entrance of the first notch is greater than the one of a) two times the first radius and b) the width of the first notch.

17. The vine removal tool of claim 13, further comprising:
an adapter defining one or more indexing openings configured to allow coupling of the adapter to an extension member, the adapter configured to be coupled to an extension member extending a length of the tool at any one of multiple angles with respect to an axis of the extension member.

18. A method of using the vine removal tool of claim 16, comprising adjusting a rotational position of the vine removal tool with respect to a handle from a first attachment angle to a second attachment angle.

19. A method of using the vine removal tool of claim 12, the method comprising:
removing vine growth from around a guy wire by sliding the vine removal tool up and down one of the guy wire and a wire guard covering the wire while
generally maintaining contact between the vine removal tool and the one of the guy wire and the wire guard.

20. A method comprising:
obtaining a vine removal tool, the vine removal tool comprising a working end defining:
a first notch defining a first radius; and
a second notch intersecting the first notch and defining a second radius, the first radius being greater than the second radius;
aligning one of the first notch and the second notch with one of a guy wire and a wire guard in which the guy wire is received or to which the guy wire is joined; and
engaging the vine removal tool with the one of the guy wire and the wire guard by sliding the vine removal tool up and down the one of the guy wire and the wire guard while generally maintaining contact between the vine removal tool and the one of the guy wire and the wire guard.
